(19) United States
(12) Patent Application Publication
(10) Pub. No.: US 2025/0229765 A1
(43) Pub. Date: Jul. 17, 2025

(54) APPARATUS FOR CONTROLLING DRIVING SYSTEMS OF HYBRID VEHICLE, DRIVING SYSTEM CONTROL METHOD THEREOF, AND SYSTEM INCLUDING THE SAME

(71) Applicants: Hyundai Motor Company, Seoul (KR); Kia Corporation, Seoul (KR)

(72) Inventors: Jin Kyeom Cho, Suwon-si (KR); Hyeon Taek Choi, Bucheon-si (KR); Ye Eun Lee, Incheon (KR); Seok Cheon Jeon, Seoul (KR); Han Seung Myoung, Taean-eup (KR); Dong Hyeon Woo, Daegu (KR)

(73) Assignees: Hyundai Motor Company, Seoul (KR); Kia Corporation, Seoul (KR)

(21) Appl. No.: 18/809,891

(22) Filed: Aug. 20, 2024

(30) Foreign Application Priority Data
Jan. 11, 2024 (KR) 10-2024-0005042

(51) Int. Cl. B60W 20/15; B60W 10/06; B60W 10/08; B60W 50/08

(52) U.S. Cl. CPC B60W 20/15; B60W 10/06; B60W 10/08; B60W 50/082; B60W 2510/0657; B60W 2510/083; B60W 2510/248; B60W 2710/0666; B60W 2710/083

(57) ABSTRACT

In an apparatus for controlling a driving system of a hybrid vehicle and a driving system control method thereof, the torque of an internal combustion driving system and the torque of an electric driving system in the hybrid vehicle are controlled according to the states of the internal combustion driving system and the electric driving system, so that the states of the driving systems in the hybrid vehicle may be maintained in balance, raising a residual value of the vehicle.

### CROSS REFERENCE TO RELATED APPLICATION

The present application claims priority to Korean Patent Application No. 10-2024-0005042, filed Jan. 11, 2024, the entire contents of which is incorporated herein for all purposes by this reference.

### BACKGROUND OF THE PRESENT DISCLOSURE

### Field of the Present Disclosure

The present disclosure relates to technology for controlling driving systems of a hybrid vehicle, and more particularly to an apparatus for controlling a driving system of a hybrid vehicle, a driving system control method thereof, and a system including the same, in which the torque of an internal combustion driving system and the torque of an electric driving system in the hybrid vehicle are controlled according to the states of the internal combustion driving system and the electric driving system, so that the states of the driving systems in the hybrid vehicle may be maintained in balance, preserving or raising a residual value of the vehicle.

### Description of Related Art

With development of vehicle industries, the useful life of the vehicle has increased, and thus there has been widely spread awareness that the performance of used vehicles is not much different from that of new vehicles. Furthermore, the more and more people are seeking to buy the used vehicle to relieve the cost increasing burden of purchasing the new vehicle, and the size of used vehicle sales market is expanding.

The residual value of a vehicle is an important factor in the price and marketability of the vehicle, and thus the vehicle needs to be managed to raise the residual value of the vehicle.

Because the vehicle performs based on a mounted power source, a power system is very important for the performance of the vehicle, and the well-preserved power system of the vehicle is very effective in raising the residual value of the vehicle.

A hybrid vehicle (HV) is mounted with an engine and a motor as the power sources, and provides optimal output and torque according to how the engine and the motor are driven.

In such an HV, the engine and the motor, i.e., the power sources are not only individually used in determining the residual value, but also commonly used in determining the residual value of the overall power sources.

Therefore, it is required to raise the residual value of the HV by keeping the states of the engine and motor in balance.

Furthermore, the well-preserved power system of the vehicle is not only necessary for the price or marketability in the used vehicle sales market, but also very important for a user to drive the vehicle safely and stably.

The residual value of the HV may be varied depending on the residual values of individual major parts (e.g., the engine, the motor, etc.) in the vehicle, and may be in particular largely affected by the part having the lowest residual value among the parts. For example, if the residual value of a specific major part in the vehicle is excessively lower than those of the other major parts, the overall residual value of the HV may be evaluated based on the low residual value of the specific major part regardless of the other major parts' residual values.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus for controlling a driving system of a hybrid vehicle, a driving system control method thereof, and a system including the same, in which the states of the driving systems in the hybrid vehicle may be maintained in balance, preserving or raising a residual value of the vehicle.

Another aspect of the present disclosure is to provide an apparatus for controlling a driving system of a hybrid vehicle, a driving system control method thereof, and a system including the same, in which a torque ratio between an internal combustion driving system and an electric driving system is controlled based on the states of the internal combustion driving system and the electric driving system in the hybrid vehicle.

Yet another aspect of the present disclosure is to provide an apparatus for controlling a driving system of a hybrid vehicle, a driving system control method thereof, and a system including the same, in which the torque of an internal combustion driving system and the torque of an electric driving system are controlled based on the deterioration state of the internal combustion driving system and the deterioration state of the electric driving system in the hybrid vehicle.

Yet another aspect of the present disclosure is to provide an apparatus for controlling a driving system of a hybrid vehicle, a driving system control method thereof, and a system including the same, which allow a user to determine whether to perform balance control for an internal combustion driving system and an electric driving system in the hybrid vehicle, improving customer satisfaction and marketability.

Yet another aspect of the present disclosure is to provide an apparatus for controlling a driving system of a hybrid vehicle, a driving system control method thereof, and a system including the same, which are effectively applied to autonomous vehicles by determining the residual value based on the states of an internal combustion driving system and an electric driving system in the hybrid vehicle, and automatically controlling the driving systems based on the residual value of the internal combustion/electric driving system.

Technical problems to be solved in the present disclosure are not limited to the forementioned technical problems, and other unmentioned technical problems may be clearly understood from the following description by a person including ordinary knowledge in the art to which the present disclosure pertains.

As technical means for achieving the foregoing technical subjects, there are provided an apparatus for controlling a driving system of a hybrid vehicle, a driving system control method thereof, and a system including the same, in which the states of the driving systems in the hybrid vehicle are maintained in balance, preserving or raising a residual value of the vehicle.

According to an exemplary embodiment of the present disclosure, the apparatus for controlling the driving system of the hybrid vehicle may include a driving system controller configured to determine residual values of the internal combustion driving system and the electric driving system based on driving system state information, compare the residual value of the internal combustion driving system and the residual value of the electric driving system, and increase torque of a driving system including a high residual value and decrease torque of a driving system including a low residual value among the internal combustion driving system and the electric driving system in terms of satisfying required torque.

According to an exemplary embodiment of the present disclosure, the internal combustion driving system may include an engine, and the electric driving system may include a motor and a battery.

According to an exemplary embodiment of the present disclosure, the driving system controller may be configured to determine the residual value of the internal combustion driving system based on a deterioration degree of an engine, and determine the residual value of the electric driving system based on a deterioration degree of a motor and a deterioration degree of a battery.

According to an exemplary embodiment of the present disclosure, the driving system controller may perform driving system balance control in response that a driving system balance control function is activated, a vehicle driving mode is a hybrid mode, and the residual value of the internal combustion driving system is different from the residual value of the electric driving system.

According to an exemplary embodiment of the present disclosure, the driving system controller may be configured to determine the residual value of the hybrid vehicle based on the residual value of the internal combustion driving system and the residual value of the electric driving system.

According to an exemplary embodiment of the present disclosure, the driving system controller may be configured to determine a torque increment of a torque increasing driving system, determine control torque of the torque increasing driving system by adding the torque increment to current torque of the torque increasing driving system, and determine control torque of a torque decreasing driving system by subtracting the control torque of the torque increasing driving system from total required torque.

According to an exemplary embodiment of the present disclosure, the driving system controller may be configured to determine a torque increment of an engine in response that the residual value of the internal combustion driving system is greater than the residual value of the electric driving system, determine engine control torque by adding the torque increment to current torque of the engine, and determine motor control torque by subtracting the engine control torque from total required torque.

According to an exemplary embodiment of the present disclosure, the driving system controller may be configured to determine a torque increment of a motor in response that the residual value of the electric driving system is greater than the residual value of the internal combustion driving system, determine motor control torque by adding the torque increment to current torque of the motor, and determine engine control torque by subtracting the motor control torque from total required torque.

According to an exemplary embodiment of the present disclosure, the driving system controller may be configured to determine the torque increment with reference to an increment lookup table where torque increments are tabulated corresponding to the residual values of the internal combustion system and the electric driving system.

According to an exemplary embodiment of the present disclosure, the driving system controller may be configured to determine the torque increment with reference to an increment lookup table for each control level, in which torque increments are tabulated corresponding to the residual values and control levels of the internal combustion system and the electric driving system, to reflect a driving system balance control level.

According to an exemplary embodiment of the present disclosure, a method of controlling driving systems in a hybrid vehicle may include: determining residual values of the internal combustion driving system and the electric driving system based on driving system state information; comparing the residual value of the internal combustion driving system and the residual value of the electric driving system; and performing driving system balance control by increasing torque of a driving system including a high residual value and decreasing torque of a driving system including a low residual value based on comparison results, in terms of satisfying required torque.

According to an exemplary embodiment of the present disclosure, the determining may include determining the residual value of the internal combustion driving system based on a deterioration degree of an engine, and determining the residual value of the electric driving system based on a deterioration degree of a motor and a deterioration degree of a battery.

According to an exemplary embodiment of the present disclosure, the determining may include determining a residual value of the hybrid vehicle based on the residual value of the internal combustion driving system and the residual value of the electric driving system.

According to an exemplary embodiment of the present disclosure, the comparing may be performed in response that a driving system balance control function is activated, a vehicle driving mode is a hybrid mode, and the residual value of the internal combustion driving system is different from the residual value of the electric driving system.

According to an exemplary embodiment of the present disclosure, the performing the driving system balance control may include determining a torque increment of a torque increasing driving system, determining control torque of the torque increasing driving system by adding the torque increment to current torque of the torque increasing driving system, and determining control torque of a torque decreasing driving system by subtracting the control torque of the torque increasing driving system from the total required torque.

According to an exemplary embodiment of the present disclosure, the performing the driving system balance control may include determining a torque increment of an engine in response that the residual value of the internal combustion driving system is greater than the residual value of the electric driving system, determining engine control torque by adding the torque increment to current torque of the engine, and determining motor control torque by subtracting the engine control torque from the total required torque.

According to an exemplary embodiment of the present disclosure, the performing the driving system balance control may include determining a torque increment of a motor in response that the residual value of the electric driving system is greater than the residual value of the internal combustion driving system, determining motor control torque by adding the torque increment to current torque of the motor, and determining engine control torque by subtracting the motor control torque from the total required torque.

According to an exemplary embodiment of the present disclosure, the performing the driving system balance control may include determining the torque increment with reference to an increment lookup table where torque increments are tabulated corresponding to the residual values of the internal combustion system and the electric driving system.

According to an exemplary embodiment of the present disclosure, the performing the driving system balance control may include determining the torque increment with reference to an increment lookup table for each control level, in which torque increments are tabulated corresponding to the residual values and control levels of the internal combustion system and the electric driving system, to reflect a driving system balance control level.

According to an exemplary embodiment of the present disclosure, a system for controlling driving systems in a hybrid vehicle includes: a user input interface configured to receive setting information; a driving system state information provider that provides state information related to the driving systems of the hybrid vehicle; the foregoing driving system controller in a hybrid vehicle; and a subordinate controller operatively connected to the driving system controller and configured to control a powertrain apparatus based on driving system balance control of the driving system controller in the hybrid vehicle.

Besides the foregoing means for solving the problems, specific details based on various examples of the present disclosure are included in the following descriptions and the accompanying drawings.

According to an exemplary embodiment of the present disclosure, there may be provided an apparatus for controlling a driving system of a hybrid vehicle, a driving system control method thereof, and a system including the same, in which the states of the driving systems in the hybrid vehicle may be maintained in balance, preserving or raising a residual value of the vehicle.

Another exemplary embodiment of the present disclosure may provide an apparatus for controlling a driving system of a hybrid vehicle, a driving system control method thereof, and a system including the same, in which a torque ratio between an internal combustion driving system and an electric driving system is controlled based on the states of the internal combustion driving system and the electric driving system in the hybrid vehicle.

Various exemplary embodiments of the present disclosure may provide an apparatus for controlling a driving system of a hybrid vehicle, a driving system control method thereof, and a system including the same, in which the torque of an internal combustion driving system and the torque of an electric driving system are controlled based on the deterioration state of the internal combustion driving system and the deterioration state of the electric driving system in the hybrid vehicle.

Various exemplary embodiments of the present disclosure may provide an apparatus for controlling a driving system of a hybrid vehicle, a driving system control method thereof, and a system including the same, which allow a user to determine whether to perform balance control for an internal combustion driving system and an electric driving system in the hybrid vehicle, improving customer satisfaction and marketability.

Various exemplary embodiments of the present disclosure may provide an apparatus for controlling a driving system of a hybrid vehicle, a driving system control method thereof, and a system including the same, which are effectively applied to autonomous vehicles by determining the residual value based on the states of an internal combustion driving system and an electric driving system in the hybrid vehicle, and automatically controlling the driving systems based on the residual value of the internal combustion/electric driving system.

With the exemplary embodiments of the present disclosure, the residual value of the hybrid vehicle is preserved or raised by controlling the driving systems for the vehicle in balance. Thus, in terms of price and marketability, the hybrid vehicle is expected to gain an advantage over other vehicles in a used vehicle sales market.

Furthermore, with the exemplary embodiments of the present disclosure, the internal combustion driving system and the electric driving system in the hybrid vehicle are maintained in balance. Thus, an effect of driving the vehicle safely and stably is expected.

The effects to be obtainable from the present disclosure are not limited to the forementioned effects, and other unmentioned effects may be clearly understood from the following description by a person having ordinary knowledge in the art to which the present disclosure pertains.

The problems to be solved, the means for solving the problems, and the effects, which are described above, do not specify the essential features of the appended claims, and thus the scope of the appended claims are not limited by the matters included in the detailed description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

The accompanying drawings are intended to provide a further understanding of embodiments of the present disclosure, and provide detailed illustration and detailed description. However, the technical features of the exemplary embodiments are not limited to specific drawings, and the features included in the drawings may be combined to implement a new embodiment.

FIG. 1 illustrates a configuration of a control system in a hybrid vehicle according to an exemplary embodiment of the present disclosure.

FIG. 2 illustrates a configuration of a powertrain apparatus which may be applied to a control system in a hybrid vehicle according to an exemplary embodiment of the present disclosure.

FIG. 3 is a block diagram showing an example of hybrid-vehicle control lines which may be applied to a control system in a hybrid vehicle according to an exemplary embodiment of the present disclosure.

FIG. 4 illustrates a configuration of a superordinate controller (or a control device for a hybrid vehicle driving system) according to an exemplary embodiment of the present disclosure.

FIG. 5 illustrates a configuration of a driving system controller according to an exemplary embodiment of the present disclosure.

FIG. 6A, FIG. 6B, and FIG. 6C are diagrams for describing a case where a residual value of a vehicle is raised by controlling driving systems in balance according to an exemplary embodiment of the present disclosure.

FIG. 7A is a diagram showing change in torque when engine torque is increased while driving system balance control according to an exemplary embodiment of the present disclosure.

FIG. 7B is a diagram showing change in torque when motor torque is increased while driving system balance control according to an exemplary embodiment of the present disclosure.

FIG. 8 is a flowchart for describing a driving system control method of a hybrid vehicle according to an exemplary embodiment of the present disclosure.

FIG. 9 is a flowchart for describing detailed operations of the driving system balance control S850 in FIG. 8.

FIG. 10 is a flowchart for describing an overall process of residual value preservation control for a hybrid vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Advantages and features of the present disclosure and methods of achieving them will become apparent with reference to the exemplary embodiments described below in detail However, the present disclosure may be implemented in various different forms, not limited to the exemplary embodiments included below. These embodiments only make the present disclosure complete, and are provided to fully inform those skilled in the art of the scope of the present disclosure, and the present disclosure is only defined by the scope of the claims.

The shapes, sizes, proportions, angles, numbers, and the like illustrated in the drawings for describing the exemplary embodiments of the present disclosure are exemplary, and thus the present disclosure is not limited to the illustrations. Like reference numerals denote the same elements throughout the specification. Furthermore, lest it should obscure the subject matter of the present disclosure, a detailed description of a related known technology will be omitted. When the terms “include”, “have”, “comprise”, and the like are used in the specification, they mean that other elements may be added unless “only” is used. A singular form may include plural referents, unless specifically stated otherwise.

When a component is interpreted, it is interpreted as including an error range, even when there is no explicit description of the error range.

In a description of a temporal relationship, when the temporal precedence is described by “after”, “following”, “after”, “before”, and the like, it may cover non-continuity unless “immediately” or “directly” is used.

Although first, second, and the like are used to describe various components, these components are not limited by these terms. These terms are only used to distinguish one component from another. Accordingly, a first component mentioned below may be a second component within the spirit of the present disclosure.

In describing components of the present disclosure, terms such as first, second, A, B, (a), (b), and the like may be used. These terms are only for distinguishing one component form another, and the nature, order, order, or number of components is not limited by the terms. When it is described that a component is “connected to”, “coupled with” or “coupled to” another component, the component may be directly connected to the other component. However, unless specifically stated otherwise, it should be understood that the component may be connected to the other component indirectly or with a third component “interposed” therebetween.

“At least one” should be understood as including all possible combinations of one or more of associated components. For example, the meaning of “at least one of a first component, a second component, or a third component” includes not only the first, second, or third component, but also all combinations of two or more of the first, second, and third components.

The features of various embodiments of the present disclosure may be partially or wholly combined with each other, and various technical interactions and operations are possible. The exemplary embodiments of the present disclosure may be implemented independently or together in a related relationship.

Components shown in the drawings are not true to scale, for convenience of description, and thus should not be construed as limiting.

Below, an apparatus for controlling a driving system of a hybrid vehicle according to various exemplary embodiments of the present disclosure, a driving system control method thereof, and a system including the same will be described with reference to the accompanying drawings.

In a hybrid vehicle where a control system 1 according to an exemplary embodiment of the present disclosure is implemented, operations of a component including a relatively low residual value among major components such as a plurality of driving systems and a clutch are inhibited by residual value preservation control, so that the residual value of any one of the major components is not significantly lower than but balanced with those of the other components, efficiently managing a total residual value of the vehicle.

Here, each residual value of the major components such as the driving system and the clutch, provided in the vehicle, may refer to the current value reflecting depreciation caused by use, with respect to an unused state value such as a factory price.

Such a residual value may be determined through inspection for at least one predetermined evaluation item, and the evaluation item may include quality, performance, state, etc. Furthermore, the evaluation item may be evaluated based on total operation amount, total operation time, etc., and the evaluation may take the characteristics of each component into account.

For example, the residual value of the internal combustion driving system may be determined by considering the amount of fuel consumed, overheating history, vibration and noise generation history, cylinder pressure, etc., and the residual value of the electric driving system may be determined by considering charging and discharging history of a battery, degree of battery deterioration, the output voltage, frequency and power conversion efficiency of an inverter, etc. Furthermore, the residual value of the clutch may be determined by considering the engagement/disengagement history of the clutch, etc.

Such residual values of the components may be autonomously determined by controllers provided in the hybrid vehicle, such as a hybrid controller, an engine control unit, a motor control unit, and a clutch control unit, or may be determined by a separate device. However, the exemplary embodiments of the present disclosure may be applied regardless of specific methods of determining the residual values.

Meanwhile, the total residual value of the vehicle may be determined based on the residual values of the major components. The total residual value of the vehicle may be determined being largely affected by the component including a relatively low residual value. For example, the total residual value of the vehicle may be determined based on the residual value of the component including the lowest residual value regardless of the residual values of the other components.

Driving mode control, operating point control and clutch control may be performed to preserve or raise the residual value of the hybrid vehicle.

The driving mode control may be achieved by adjusting at least one power output condition of the internal combustion driving system and the electric driving system.

According to the power output conditions, it may be determined whether the power may be output through each driving system, or how much power may be output through each driving system. by adjusting the power output conditions, the operation of each driving system may be inhibited or aroused. For example, when the operation of a specific driving system is inhibited, a frequency with which that driving system outputs power, a period during which that driving system outputs power, a level of power output by that driving system, etc. may be decreased. When the operation of a specific driving system is aroused, the frequency with which that driving system outputs power, the period during which that driving system outputs power, the level of power output by that driving system, etc. may be increased.

To alleviate decline in the residual value of the driving system including a relatively low residual value, the driving mode control may be achieved by highly adjusting the power output condition of the driving system, the residual value of which is low, between the internal combustion driving system and the electric driving system.

When the power output condition of the driving system including a relatively low residual value is highly adjusted (in other words, when it becomes difficult for that driving system to output power), the proportion of the power from the driving system including a relatively low residual value, which drives the vehicle, may be decreased.

As the proportion of the power from a specific driving system, which drives the vehicle, increases, the operations of that driving system are increased, decreasing the residual value. In the present way, the decline in the residual value of a specific driving system is alleviated by reducing the proportion of driving the vehicle through that driving system.

Therefore, when the power output conditions of the driving system including a low residual value are highly adjusted, the decline in the residual value of the driving system including the low residual value may be alleviated, alleviating the decline in the residual value of the overall vehicle depending on the residual value of the driving system including the low residual value.

Furthermore, the driving mode control may be achieved by lowly adjusting the power output conditions of the driving system including a relatively high residual value (in other words, by easing the power output of that driving system).

In the instant case, the proportion of the power from the driving system including a relatively high residual value, which drives the vehicle, may be increased, decreasing the proportion of the power from the driving system including a relatively low residual value, and resulting in alleviating the decline in the residual value of the driving system including the low residual value.

In the instant case, the driving system including a relatively high residual value may be decreased in the residual value, but has a minor effect on the total residual value of the vehicle as compared with the driving system including a relatively low residual value. In terms of the overall driving systems, the residual value of the vehicle is efficiently preserved while satisfying the power for driving the vehicle.

The operating point control may be achieved by adjusting a distribution ratio of torque required for the internal combustion driving system and the electric driving system.

For example, the operating point control may be achieved by lowering the distribution ratio of the torque required for the driving system including a relatively low residual value between the internal combustion driving system and the electric driving system and increasing the distribution ratio of the torque required for the driving system including a relatively high residual value. Therefore, the output of the driving system including a relatively low residual value is reduced, alleviating the decline in the residual value.

The clutch control may be achieved by highly adjusting an engagement state changing condition of the clutch.

When the engagement state changing condition of the clutch is highly adjusted, it becomes difficult for the clutch to change from an engagement state to a disengagement state or from the disengagement state to the engagement state, reducing the state change of the clutch. The more frequently the clutch is changed in state, the more the residual value of the clutch may be lowered. Therefore, the decline in the residual value of the clutch is alleviated by highly adjusting the engagement state changing condition as above.

Below, an apparatus for controlling a driving system of a hybrid vehicle, a driving system control method thereof, and a system including the same will be described focusing on the operating point control.

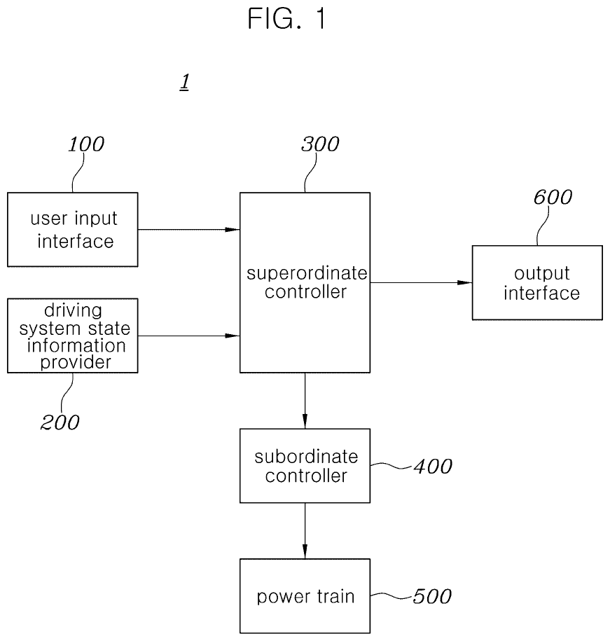

FIG. 1 illustrates a configuration of the control system 1 in a hybrid vehicle according to an exemplary embodiment of the present disclosure.

The control system 1 in the hybrid vehicle (or an HV driving-system control system or a driving-system control system) according to an exemplary embodiment of the present disclosure may be implemented to preserve or raise the residual value of the hybrid vehicle by maintaining the states of different driving systems of the hybrid vehicle in balance.

In other words, balance control to be described below may be performed to preserve or raise the residual value of the hybrid vehicle.

Furthermore, the control system 1 according to various exemplary embodiments of the present disclosure may be implemented to control the internal combustion driving system and the electric driving system according to the states of the internal combustion driving system and the electric driving system in the hybrid vehicle.

The control system 1 according to various exemplary embodiments of the present disclosure may be implemented to control the torque of the internal combustion driving system and the torque of the electric driving system based on deterioration states of the internal combustion driving system and the electric driving system in the hybrid vehicle.

The control system 1 according to various exemplary embodiments of the present disclosure may be implemented to allow a user to determine whether to perform balance control for the internal combustion driving system and the electric driving system in the hybrid vehicle.

The control system 1 according to various exemplary embodiments of the present disclosure may perform the balance control for the internal combustion driving system and the electric driving system based on setting information input by a user, and driving system state information.

Furthermore, the control system 1 according to various exemplary embodiments of the present disclosure may be implemented to automatically determine the residual values according to the states of the driving systems, and control the driving systems based on the residual values.

Referring to FIG. 1, the control system 1 according to an exemplary embodiment of the present disclosure may include, but not limited to, a user input interface 100, a driving system state information provider 200, a superordinate controller 300, a subordinate controller 400, a powertrain apparatus 500, and an output interface 600.

The user input interface 100, which refers to a means for a user's input, may receive information input by a user, and provide the input information to the superordinate controller 300. According to an exemplary embodiment of the present disclosure, the information input by a user relates to settings for a driving system balance control function, which will be hereinafter referred to as setting information (or balance control setting information).

For example, the user input interface 100 may be user setting menu or user select manual (USM), but the type of the user input interface 100 is not limited thereto.

For instance, the user input interface 100 may receive information related to whether the driving system balance control function is activated (e.g., activated (ON) or deactivated (OFF)), a driving system balance control level (e.g., 0, high, middle, and low), etc., but the setting information input through the user input interface 100 is not limited thereto. Here, the driving system balance control level of ‘0’ may indicate that a separate weight is not applied to the driving system balance control.

The setting information input through the user input interface 100 may be changed, and the changed setting information may be provided to the superordinate controller 300 in real time.

The driving system state information provider 200 may obtain (or collect) information related to the driving systems of the hybrid vehicle, and provide the obtained information to the superordinate controller 300.

According to an exemplary embodiment of the present disclosure, the information obtained by the driving system state information provider 200 and provided to the superordinate controller 300 refers to information related to the states of the driving systems, which will be hereinafter referred to as driving system state information.

For example, the driving system state information provider 200 may provide state information related to the internal combustion driving system, and state information related to the electric driving system. According to an exemplary embodiment of the present disclosure, the internal combustion driving system may include an engine, the electric driving system may include a motor and a battery, and the state information may include a deterioration degree.

Thus, the driving system state information provider 200 may provide the deterioration degree of the engine, the deterioration degree of the motor, and the deterioration degree of the battery to the superordinate controller 300, but the information provided by the driving system state information provider 200 is not limited thereto. For example, the driving system state information provider 200 includes an engine control unit (ECU) to control operation of an engine, a motor control unit (MCU) to control operation of a motor, a battery management system (BMS) to control and manage a battery, etc.

The superordinate controller 300 (or a hybrid vehicle driving system control device) may receive the setting information from the user input interface 100, and may receive the driving system state information from the driving system state information provider 200.

For example, the superordinate controller 300 may be a hybrid control unit (HCU), but is not limited thereto.

The superordinate controller 300 may be configured to determine the activation of the driving system balance control function and the level of the driving system balance control based on the setting information, and may be configured to determine the deterioration degrees of the driving system based on the driving system state information.

The superordinate controller 300 may be configured to determine the residual values of the driving systems based on the state information of the driving systems. For example, the residual value of the driving system may refer to life expectancy.

According to an exemplary embodiment of the present disclosure, the superordinate controller 300 may be configured to determine the residual value of the internal combustion driving system based on the deterioration degree of the engine, and may be configured to determine the residual value of the electric driving system based on the deterioration degree of the motor and the deterioration degree of the battery.

Furthermore, the superordinate controller 300 may be configured to determine the residual value of a corresponding hybrid vehicle based on the determined residual values of the driving systems. For example, the residual value of the vehicle may indicate the price of the vehicle.

To the present end, the superordinate controller 300 may store a driving system residual value lookup table (LUT) previously set by analyzing the residual values of the driving systems based on the deterioration degrees of the driving systems, and a vehicle residual value lookup table previously set by analyzing the residual value of the vehicle according to the residual value of the internal combustion driving system and the residual value of the electric driving system.

For example, the driving system residual value lookup table may be implemented by analyzing big data related to the residual values (e.g., life expectancy) of the driving systems according to the deterioration degrees of the driving systems, and the vehicle residual value lookup table may be implemented by analyzing big data related to the residual value (e.g., the price) of the vehicle according to the residual value of the internal combustion driving system and the residual value of the electric driving system.

For example, the driving system residual value lookup table may include an internal combustion driving system residual value lookup table implemented by analyzing the big data related to the residual value of the internal combustion driving system according to the deterioration degree of the engine, and an electric driving system residual value lookup table implemented by analyzing the big data related to the residual value of the electric driving system according to the deterioration degree of the motor and the deterioration degree of the battery.

The superordinate controller 300 may output the determined residual value and vehicle price through the output interface 600.

According to an exemplary embodiment of the present disclosure, the superordinate controller 300 may be configured to determine the residual value (e.g., life expectancy) of the driving system and the residual value (e.g., price) of the vehicle regardless of whether the driving system balance control function is activated.

In other words, the superordinate controller 300 may be configured to determine the residual values of the driving systems and the vehicle before the driving system balance control function is activated, and may be configured to determine the residual values of the driving systems and the vehicle after the driving system balance control function is activated.

For description, the residual value determined before activating the driving system balance control function will be referred to as an initial (or current) residual value, and the residual values of the driving systems and the price of the vehicle, which are changed (or adjusted) by the driving system balance control performed as the driving system balance control function is activated, will be referred to as a changed residual value.

Thus, the superordinate controller 300 may be configured to determine the initial (or current) residual values of the driving systems and the initial (or current) residual value of the vehicle before activating the driving system balance control function, and determine the changed residual value of the driving system and the changed residual value of the vehicle after the driving system balance control.

According to an exemplary embodiment of the present disclosure, the superordinate controller 300 may be configured to determine the initial (or current) residual value of the internal combustion driving system and the initial (or current) residual value of the electric driving system as the initial residual values of the driving systems, and determine the changed residual value of the internal combustion driving system and the changed residual value of the electric driving system as the changed residual values of the driving systems.

According to an exemplary embodiment of the present disclosure, the superordinate controller 300 may perform the driving system balance control when the driving system balance control function is activated.

To the present end, the superordinate controller 300 may store a driving system balance control algorithm programmed to implement the driving system balance control according to an exemplary embodiment of the present disclosure.

The superordinate controller 300 may be configured to determine a current driving mode of the vehicle, and perform the driving system balance control based on the driving system balance control algorithm in the case of a hybrid mode (or HEV mode).

The superordinate controller 300 may be configured to determine whether a driving system balance control condition is satisfied based on the residual values of the driving system, and perform the driving system balance control when the driving system balance control condition is satisfied.

According to an exemplary embodiment of the present disclosure, the superordinate controller 300 may be configured to determine that the driving system balance control condition is not satisfied when the residual value of the internal combustion driving system and the residual value the electric driving system are equal to each other, and determine the driving system balance control condition is satisfied when the residual value of the internal combustion driving system and the residual value the electric driving system are different from each other.

The superordinate controller 300 may perform the driving system balance control based on a driving system balance control level and a driving system residual value when the driving system balance control condition is satisfied.

According to an exemplary embodiment of the present disclosure, the superordinate controller 300 may increase the torque of the engine and decrease the torque of the motor when the residual value V_{PT} of the internal combustion driving system is greater than the residual value V_{PE} of the electric driving system (V_{PT}>V_{PE}).

Furthermore, the superordinate controller 300 may decrease the torque of the engine and increase the torque of the motor when the residual value V_{PT} of the internal combustion driving system is smaller than the residual value V_{PE} of the electric driving system (V_{PT}<V_{PE}).

In the present way, the superordinate controller 300 may perform the driving system balance control by increasing the torque of the driving system including a high residual value and decreasing the torque of the driving system including a low residual value.

For description, the driving system (engine or motor), the torque of which is increased, will be referred to as a torque increasing driving system, and the driving system (engine or motor), the torque of which is decreased, will be referred to as a torque decreasing driving system.

According to an exemplary embodiment of the present disclosure, the superordinate controller 300 may be configured to determine a torque increment (or increased value) of the torque increasing driving system, determine output torque of the torque increasing driving system by adding the increment to the current torque of the torque increasing driving system, and determine output torque of the torque decreasing driving system by subtracting the output torque of the torque increasing driving system from total required torque.

For example, the superordinate controller 300 may be configured to determine the torque increment of the engine when the residual value V_{PT} of the internal combustion driving system is greater than the residual value V_{PE} of the electric driving system (V_{PT}>V_{PE}), determine the output torque of the engine (or engine control torque) by adding the torque increment to the current torque of the engine, and determine the output torque of the motor (or motor control torque) by subtracting the output torque of the engine from the total required torque.

For example, the superordinate controller 300 may be configured to determine the torque increment Δτ of the motor when the residual value V_{PE} of the electric driving system is greater than the residual value V_{PT} of the internal combustion driving system (V_{PE}>V_{PT}), determine the output torque of the motor (or motor control torque) by adding the torque increment to the current torque of the motor, and determine the output torque of the engine (or engine control torque) by subtracting the output torque of the motor from the total required torque.

In the present way, the superordinate controller 300 according to various exemplary embodiments of the present disclosure may perform the balance control between the residual value of the internal combustion driving system and the residual value of the electric driving system by changing ratios of the engine torque and the motor torque to the total required torque.

Thus, when the residual value V_{PT} of the internal combustion driving system is greater than the residual value V_{PE} of the electric driving system (V_{PT}>V_{PE}), the ratio of the engine torque to the total required torque may be increased to correspond to the torque increment.

Furthermore, when the residual value V_{PE} of the electric driving system is greater than the residual value V_{PT} of the internal combustion driving system (V_{PE}>V_{PT}), the ratio of the motor torque to the total required torque may be increased to correspond to the torque increment.

According to an exemplary embodiment of the present disclosure, the superordinate controller 300 may refer to an increment lookup table, in which torque increments are tabulated corresponding to the residual values of the internal combustion system and the electric driving system, when determining the torque increment.

For example, the increment lookup table may be implemented by analyzing big data related to the torque increments corresponding to the residual values of the internal combustion system and the electric driving system.

For example, the increment lookup table may include an engine torque increment lookup table including engine torque increments to be used when the residual value of the internal combustion driving system is greater than the residual value of the electric driving system, and a motor torque increment lookup table including motor torque increments to be used when the residual value of the electric driving system is greater than the residual value of the internal combustion driving system.

Thus, the superordinate controller 300 may be configured to determine the engine torque increment with reference to the engine torque increment lookup table based on the current residual values of the internal combustion system and the electric driving system when the residual value of the internal combustion driving system is greater than the residual value of the electric driving system.

Furthermore, the superordinate controller 300 may be configured to determine the motor torque increment with reference to the motor torque increment lookup table based on the current residual values of the internal combustion system and the electric driving system when the residual value of the electric driving system is greater than the residual value of the internal combustion driving system.

In the present way, the superordinate controller 300 may be configured to determine the increment with reference to the increment lookup table, in which the torque increments are tabulated corresponding to the residual values of the internal combustion system and the electric driving system, when the driving system balance control level is ‘0’.

According to an exemplary embodiment of the present disclosure, the superordinate controller 300 may be configured to determine the torque increment reflecting the driving system balance control levels (e.g., high, middle, and low).

When the torque increment is determined, the superordinate controller 300 may refer to the increment lookup table for each control level, in which the torque increments are tabulated corresponding the residual values and control levels of the internal combustion system and the electric driving system.

For example, the increment lookup table for each control level may be implemented by analyzing big data related to the torque increments corresponding to the residual values and control levels of the internal combustion system and the electric driving system.

For example, the increment lookup table for each control level may include an engine torque increment lookup table for each control level, to be used when the residual value of the internal combustion driving system is greater than the residual value of the electric driving system, and a motor torque increment lookup table for each control level, to be used when the residual value of the electric driving system is greater than the residual value of the internal combustion driving system.

Thus, the superordinate controller 300 may be configured to determine the engine torque increment with reference to the engine torque increment lookup table for each control level based on the current residual values and control levels of the internal combustion system and the electric driving system, when the residual value of the internal combustion driving system is greater than the residual value of the electric driving system.

Furthermore, the superordinate controller 300 may be configured to determine the motor torque increment with reference to the motor torque increment lookup table for each control level based on the current residual values and control levels of the internal combustion system and the electric driving system, when the residual value of the electric driving system is greater than the residual value of the internal combustion driving system.

The superordinate controller 300 may output the torque (i.e., the engine control torque and the motor control torque), which are determined for each of the engine and the motor by performing the driving system balance control, to the subordinate controller 400.

The subordinate controller 400 may be configured for controlling the powertrain apparatus 500 based on the engine control torque and the motor control torque output from the superordinate controller 300.

In an exemplary embodiment of the present disclosure, each of the superordinate controller 300 and the subordinate controller 400 may be implemented by a processor in a form of hardware or software, or in a combination of hardware and software. Alternatively, the superordinate controller 300 and the subordinate controller 400 may be implemented as a single processor in a form of hardware or software, or in a combination of hardware and software.

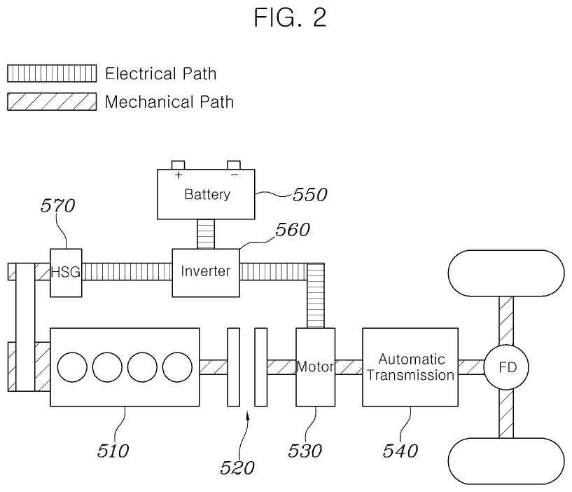

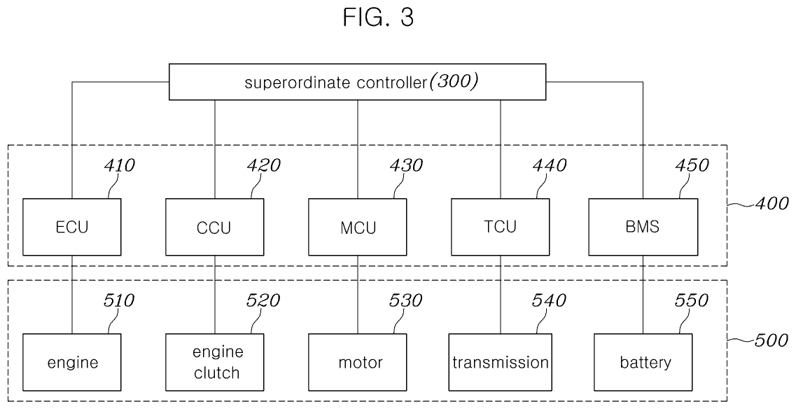

FIG. 2 illustrates a configuration of a powertrain apparatus which may be applied to a control system in a hybrid vehicle according to an exemplary embodiment of the present disclosure, and FIG. 3 is a block diagram showing an example of hybrid-vehicle control lines which may be applied to a control system in a hybrid vehicle according to an exemplary embodiment of the present disclosure.

FIG. 2 illustrates a configuration of a transmission mounted electric drive (TMED) powertrain apparatus in which a driving motor and a transmission are connected, and illustrates a powertrain apparatus employing a parallel type hybrid system in which the driving motor and the engine clutch are mounted between the internal combustion engine and the transmission.

Referring to FIG. 1, FIG. 2, and FIG. 3, the subordinate controller 400 may be configured for controlling the powertrain apparatus 500 based on the torque (i.e., the engine torque and the motor torque) output from the superordinate controller 300.

The subordinate controller 400 may be configured for controlling the configuration of the interlocking powertrain apparatus 500 under control of the superordinate controller 300.

According to an exemplary embodiment of the present disclosure, the subordinate controller 400 may include an engine control unit (ECU) 410, a clutch control unit (CCU) 420, a motor control unit (MCU) 430, a transmission control unit (TCU) 440, and a battery management system (BMS) 450.

Furthermore, the powertrain apparatus 500 may include an engine 510 and a motor 530 provided as power sources for driving the vehicle, an engine clutch 520 located between the engine 510 and the motor 530, a transmission 540 connected to an output side of the motor 530, a battery 550 provided as a power source for the motor 530 and connected to the motor 530 via an inverter 560, and the inverter 560 for driving the motor 530.

In FIG. 2, the reference numeral of ‘570’ indicates a hybrid starter and generator (HSG) connected for power transmission with the engine 510 and starting the engine 510 or generating power with rotation force transmitted from the engine 510 to charge the battery 550.

The engine control unit 410 may be configured for controlling the operation of the engine 510 based on the engine control torque output from the superordinate controller 300, and the motor control unit 430 may be configured for controlling the operation of the motor 530 based on the motor control torque output from the superordinate controller 300.

The clutch control unit 420 may be configured for controlling the operation of the engine clutch 520 based on a control command output from the superordinate controller 300, and the transmission control unit 440 may be configured for controlling the operation of the transmission 540 based on a control command output from the superordinate controller 300.

Furthermore, the battery management system 450 may collect battery state information to be used for controlling charging and discharging of the battery 550 or to be provided to other controllers, and perform control for managing the battery 550.

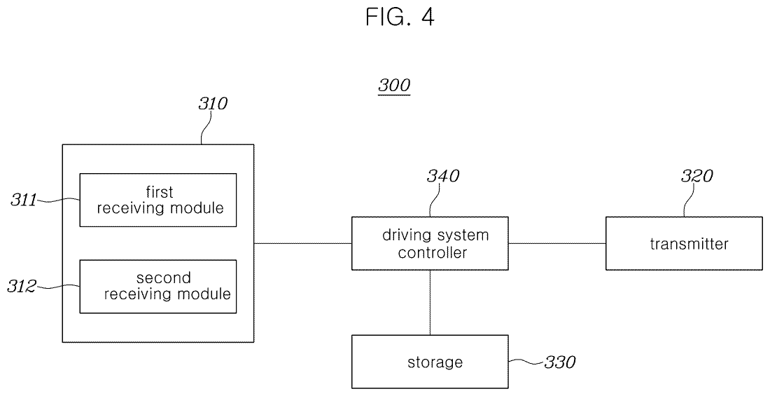

FIG. 4 illustrates a configuration of the superordinate controller (or a control device for a hybrid vehicle driving system) 300 according to an exemplary embodiment of the present disclosure.

Referring to FIG. 1, FIG. 2, FIG. 3, and FIG. 4, the superordinate controller 300 according to various exemplary embodiments of the present disclosure may be configured to determine whether to perform the balance control between the internal combustion driving system (e.g., the engine) and the electric driving system (e.g., the motor) based on the information from the outside thereof.

When the balance control is performed, the superordinate controller 300 may be configured to determine the residual values of the internal combustion driving system and the residual value of the electric driving system, and determine the engine control torque and the motor control torque for the balance control between the engine and the motor based on the determined residual values, outputting the determined torque to the subordinate controller 400.

According to an exemplary embodiment of the present disclosure, the superordinate controller 300 may include, but not limited to, a receiver 310, a transmitter 320, a storage 330, and a driving system controller 340.

The receiver 310 (or first communicator) according to various exemplary embodiments of the present disclosure may receive information from the outside thereof, and transmit the received information to the driving system controller 340.

For example, the receiver 310 may include a first receiving module 311 that receives the setting information (or balance control setting information) from the user input interface 100, and a second receiving module 312 that receives driving system state information from the driving system state information provider 200.

For example, the receiver 310 may receive information related to whether the driving system balance control function is activated (e.g., activated or deactivated), the driving system balance control level (e.g., high, middle, and low), etc. through the first receiving module 311. For example, the receiver 310 may receive the deterioration degree of the engine 510, the deterioration degree of the motor 530, the deterioration degree of the battery 550, etc. through the second receiving module 312.

The transmitter 320 (or second communicator) according to various exemplary embodiments of the present disclosure may transmit the information from the driving system controller 340 to the outside thereof. For example, the transmitter 320 may transmit a control value from the driving system controller 340 to the subordinate controller 400.

According to an exemplary embodiment of the present disclosure, the transmitter 320 may receive the engine control torque and the motor control torque from the driving system controller 340, transmit the engine control torque to the engine control unit 410, and transmit the motor control torque to the motor control unit 430.

The storage 330 according to various exemplary embodiments of the present disclosure may previously store an algorithm for performing the operations of the driving system controller 340, various pieces of information necessary for the operations of the driving system controller 340, etc., and may store information or results obtained or generated as the operations of the driving system controller 340 are performed.

According to an exemplary embodiment of the present disclosure, the storage 330 may store a driving system balance control algorithm, and various lookup tables. For example, the driving system balance control algorithm may include a residual value determination algorithm, and a control torque determination algorithm.

For example, various lookup tables may include driving system residual value lookup tables (e.g., an internal combustion driving system residual value lookup table and an electric driving system residual value lookup table), a vehicle residual value lookup table, an increment lookup table (e.g., an engine torque increment lookup table and a motor torque increment lookup table), an increment lookup table for each control level (e.g., an engine torque increment lookup table for each control level and a motor torque increment lookup table for each control level), etc.

Furthermore, the storage 330 may store the setting information (or balance control setting information), the current states of the driving systems, the initial residual values (or current residual values) of the driving systems and the vehicle, the changed residual values of the driving system and the vehicle, the total required torque, the current engine torque, the current motor torque, the torque increment, the engine control torque, the motor control torque, etc.

The storage 330 may include at least one type storage medium among flash memory type, hard disk type, micro type, and card (e.g., secured digital (SD) card or extreme digital (XD) card) type memories, random access memories (RAM), static RAM (SRAM), read only memories (ROM) programmable ROM (PROM), electrically erasable PROM (EEPROM), magnetic RAM (MRAM), and magnetic disk and optical disk type memories.

The driving system controller 340 according to an exemplary embodiment of the present disclosure is configured to perform general operations of the superordinate controller (or a hybrid vehicle driving system control device) 300, and may include at least one processor.

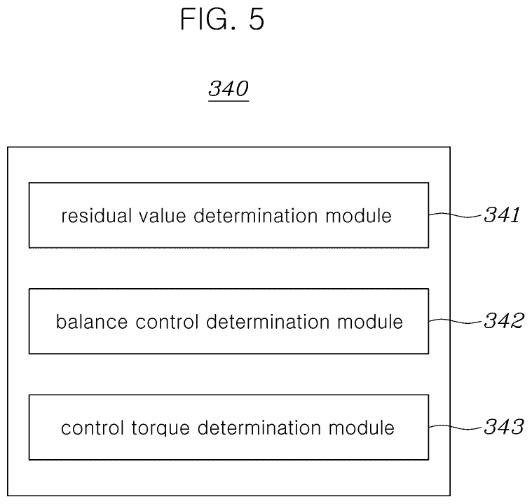

FIG. 5 illustrates a configuration of the driving system controller 340 according to an exemplary embodiment of the present disclosure.

As shown in FIG. 5, the driving system controller 340 according to an exemplary embodiment of the present disclosure may include a residual value determination module 341, a balance control determination module 342, and a control torque determination module 343 to perform functions.

According to an exemplary embodiment of the present disclosure, the driving system controller 340 may be configured to determine the residual values of the driving systems based on the driving system state information. Here, the driving system state information may be the deterioration degree of the driving system, and the residual value of the driving system may be the life expectancy.

The determination of the residual value to be described below may be performed by the residual value determination module 341.

The driving system may include the internal combustion driving system including the engine 510, and the electric driving system including the motor 530 and the battery 550.

The driving system controller 340 (or residual value determination module 341) may be configured to determine the residual value of the internal combustion driving system based on the deterioration degree of the engine 510, and may be configured to determine the residual value of the electric driving system based on the deterioration degree of the motor 530 and the deterioration degree of the battery 550.

For example, the driving system controller 340 may be configured to determine the residual value of the internal combustion driving system with reference to the internal combustion driving system residual value lookup table implemented by mapping the residual values of the internal combustion driving system with the deterioration degrees of the engine 510.

Furthermore, the driving system controller 340 may be configured to determine the residual value of the electric driving system with reference to the electric driving system residual value lookup table implemented by mapping the residual values of the electric driving system with the deterioration degrees of the motor 530 and the deterioration degree of the battery 550.

According to an exemplary embodiment of the present disclosure, the driving system controller 340 may be configured to determine the residual value of the corresponding vehicle based on the residual values of the driving systems. Here, the residual value of the vehicle may be the price of the vehicle.

The driving system controller 340 may be configured to determine the residual value of the vehicle based on the residual value of the internal combustion driving system and the residual value of the electric driving system.

For example, the driving system controller 340 may be configured to determine the residual value of the vehicle with reference to the vehicle residual value lookup table implemented by mapping the residual values of the vehicle with the residual values of the internal combustion system and the electric driving system.

The driving system controller 340 may output the deterioration degree of the engine 510, the deterioration degree of the motor 530, the deterioration degree of the battery 550, the residual value of the internal combustion driving system, the residual value of the electric driving system, and the residual value of the vehicle through the output interface 600.

The residual value determination function (or operation) of the driving system controller 340 may be performed before activating the driving system balance control function.

The driving system controller 340 may be configured to determine the initial (or current) residual values of the driving systems and the initial (or current) residual value of the vehicle by determining the residual values before activating the driving system balance control function.

Furthermore, the driving system controller 340 may be configured to determine the changed residual values of the driving systems and the changed residual value of the vehicle by determining the residual values after activating the driving system balance control function.

Here, the initial (or current) residual values of the driving system may include the initial (or current) residual value of the internal combustion driving system and the initial (or current) residual value of the electric driving system, and the changed residual values of the driving system may include the changed residual value of the internal combustion driving system and the changed residual value of the electric driving system.

The determination of whether the driving system balance control condition is satisfied, which will be described below, may be performed by the balance control determination module 342.

According to an exemplary embodiment of the present disclosure, the driving system controller 340 (or balance control determination module 342) may be configured to determine whether the driving system balance control function is activated, based on the setting information.

When the driving system balance control function is activated, the driving system controller 340 may be configured to determine whether the state of the vehicle satisfies the driving system balance control condition, based on the driving mode of the vehicle and the residual value of the driving system.

Furthermore, the driving system controller 340 may perform the driving system balance control when the state of the vehicle satisfies the driving system balance control condition.

For example, the driving system controller 340 may be configured to determine that the driving system balance control condition is satisfied when the driving mode of the vehicle is the hybrid mode (HEV mode) in which an engine and a motor are used as the power sources, and the residual value of the internal combustion driving system and the residual value of the electric driving system are different from each other.

The driving system balance control to be described below may be performed by the control torque determination module 343.

According to an exemplary embodiment of the present disclosure, the driving system controller 340 (or control torque determination module 343) may increase the torque of the engine 510 and decrease the torque of the motor 530 when the residual value V_{PT} of the internal combustion driving system is greater than the residual value V_{PE} of the electric driving system (V_{PT}>V_{PE}).

Furthermore, the driving system controller 340 may decrease the torque of the engine 510 and increase the torque of the motor 530 when the residual value V_{PT} of the internal combustion driving system is smaller than the residual value V_{PE} of the electric driving system (V_{PT}<V_{PE}). In other words, the driving system controller 340 may increase the torque of the motor 530 and decrease the torque of the engine 510 when the residual value of the electric driving system V_{PE} is greater than the residual value of the internal combustion driving system V_{PT}.

In the present way, the driving system controller 340 may increase the torque of the driving system including a high residual value, and decrease the torque of the driving system including a low residual value, performing the driving system balance control. By the driving system balance control, the driving system controller 340 may raise the residual value of the vehicle.

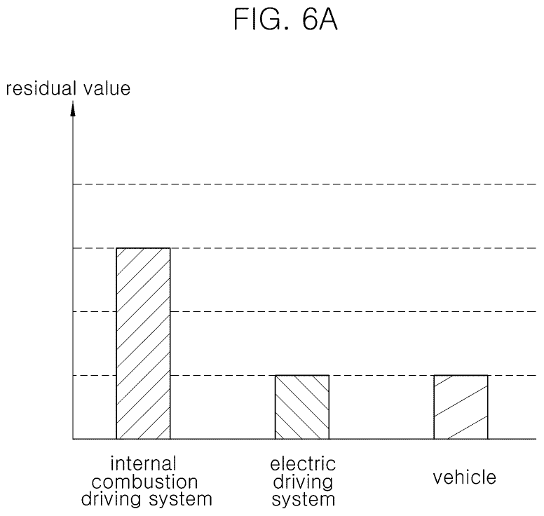

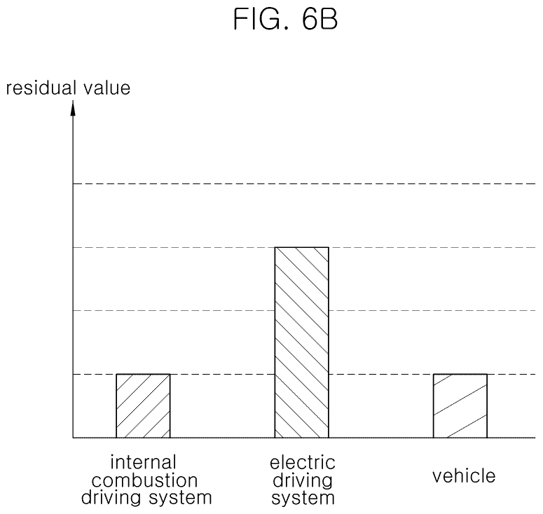

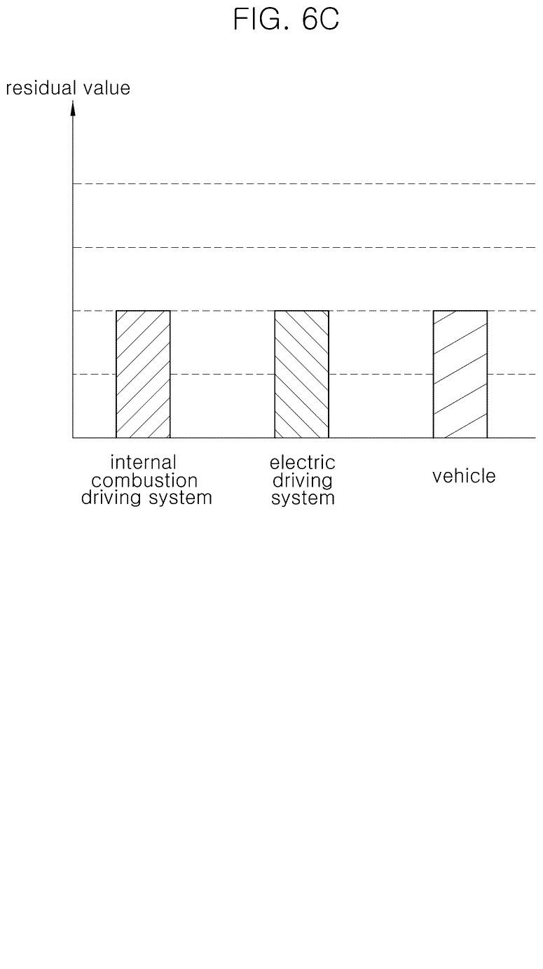

FIG. 6A, FIG. 6B, and FIG. 6C are diagrams for describing a case where a residual value of a vehicle is raised through the driving system balance control according to an exemplary embodiment of the present disclosure.

Referring to FIG. 6A, FIG. 6B, and FIG. 6C, when the residual value of the internal combustion driving system is high but the residual value of the electric driving system and the residual value of the vehicle are low as shown in FIG. 6A, or when the residual value of the electric driving system is high but the residual value of the internal combustion driving system and the residual value of the vehicle are low as shown in FIG. 6B, the driving system controller 340 may raise the residual value of the vehicle as shown in FIG. 6C through the driving system balance control.

According to an exemplary embodiment of the present disclosure, the driving system controller 340 may be configured to determine the torque increment (or increased value) of the torque increasing driving system for the driving system balance control.

Furthermore, the driving system controller 340 may be configured to determine the output torque (or control torque) of the torque increasing driving system by adding the increment to the current torque of the torque increasing driving system, and determine the output torque (or control torque) of the torque decreasing driving system by subtracting the output torque of the torque increasing driving system from the total required torque.

For example, the driving system controller 340 may be configured to determine the torque increment of the engine 510 when the residual value V_{PT} of the internal combustion driving system is greater than the residual value V_{PE} of the electric driving system (V_{PT}>V_{PE}), determine the output torque (or engine control torque) of the engine 510 by adding the torque increment to the current torque of the engine 510, and determine the output torque (or motor control torque) of the motor 530 by subtracting the output torque of the engine 510 from the total required torque.

For example, the driving system controller 340 may be configured to determine the torque increment of the motor 530 when the residual value V_{PE} of the electric driving system is greater than the residual value V_{PT} of the internal combustion driving system (V_{PE}>V_{PT}), determine the output torque (or motor control torque) of the motor 530 by adding the torque increment to the current torque of the motor 530, and determine the output torque (or motor control torque) of the engine 510 by subtracting the output torque of the motor 530 from the total required torque.

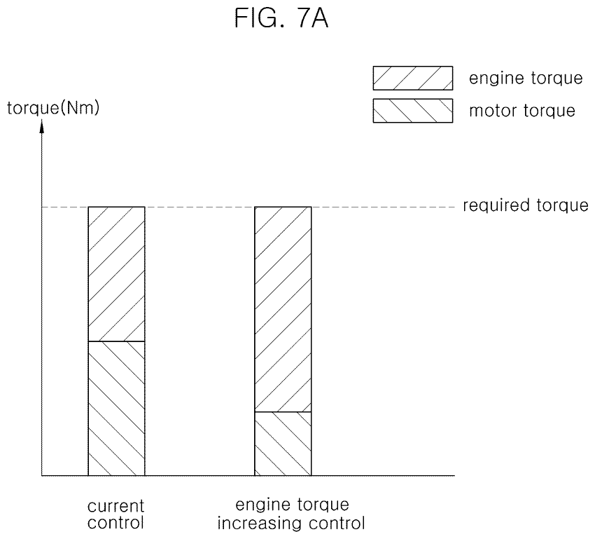

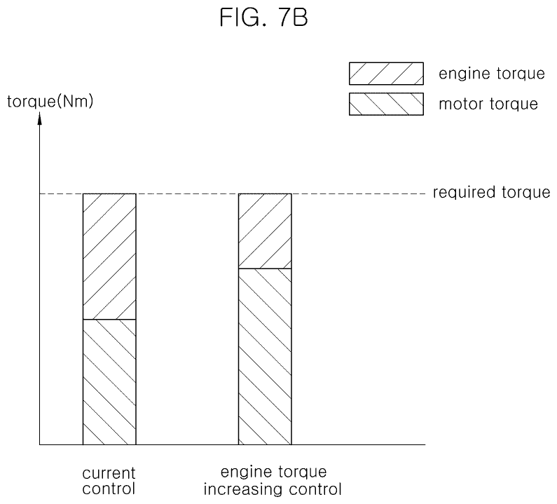

FIG. 7A is a diagram showing change in torque when engine torque is increased while driving system balance control according to an exemplary embodiment of the present disclosure, and FIG. 7B is a diagram showing change in torque when motor torque is increased while driving system balance control according to an exemplary embodiment of the present disclosure.

For description, it will be assumed that the current engine torque and the motor torque are equal to each other.

Referring to FIG. 7A, when the residual value of the internal combustion driving system is high but the residual value of the electric driving system is low as shown in FIG. 6A, the driving system controller 340 may increase the engine torque and decrease the motor torque while maintaining the total required torque.

Referring to FIG. 7B, when the residual value of the electric driving system is high but the residual value of the internal combustion driving system is low as shown in FIG. 6B, the driving system controller 340 may increase the motor torque and decrease the engine torque while maintaining the total required torque.

In the present way, the driving system controller 340 according to various exemplary embodiments of the present disclosure may perform the balance control between the residual value of the internal combustion driving system and the residual value of the electric driving system by changing ratios of the engine torque and the motor torque to the total required torque.

According to an exemplary embodiment of the present disclosure, the driving system controller 340 may refer to the increment lookup table (including the engine torque increment lookup table and the motor torque increment lookup table), in which the torque increments are tabulated corresponding to the residual values of the internal combustion system and the electric driving system, when determining the torque increment.

The driving system controller 340 may be configured to determine the engine torque increment with reference to the engine torque increment lookup table based on the current residual values of the internal combustion system and the electric driving system, when the residual value of the internal combustion driving system is greater than the residual value of the electric driving system.

Furthermore, the driving system controller 340 may be configured to determine the motor torque increment with reference to the motor torque increment lookup table based on the current residual values of the internal combustion system and the electric driving system, when the residual value of the electric driving system is greater than the residual value of the internal combustion driving system.

Meanwhile, according to an exemplary embodiment of the present disclosure, the driving system controller 340 may refer to the increment lookup table for each control level (including the engine torque increment lookup table for each control level and the motor torque increment lookup table for each control level), in which the torque increments are tabulated corresponding the residual values and control levels of the internal combustion system and the electric driving system, to determine the torque increment by reflecting the driving system balance control level (e.g., high, middle, and low).

The driving system controller 340 may be configured to determine the engine torque increment with reference to the engine torque increment lookup table for each control level based on the current residual values and control levels of the internal combustion system and the electric driving system, when the residual value of the internal combustion driving system is greater than the residual value of the electric driving system.

Furthermore, the driving system controller 340 may be configured to determine the motor torque increment with reference to the motor torque increment lookup table for each control level based on the current residual values and control levels of the internal combustion system and the electric driving system, when the residual value of the electric driving system is greater than the residual value of the internal combustion driving system.

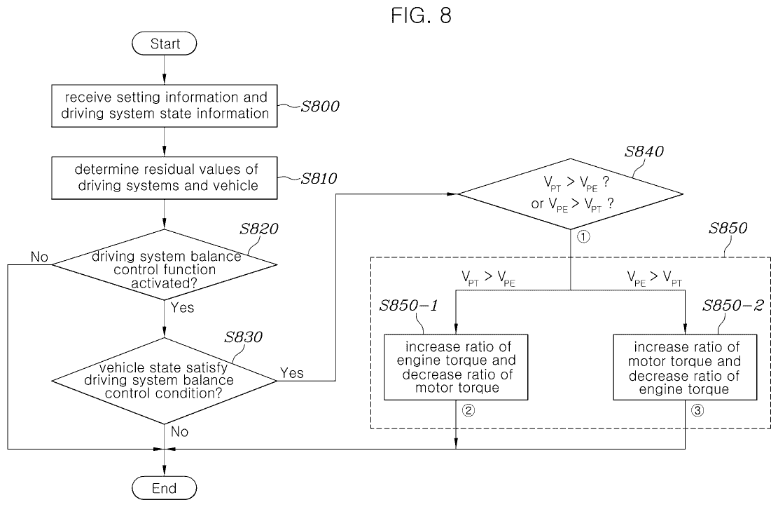

FIG. 8 is a flowchart for describing a driving system control method of a hybrid vehicle according to an exemplary embodiment of the present disclosure.

The driving system control method of the hybrid vehicle shown in FIG. 8 may be performed by the control system 1 of the hybrid vehicle described with reference to FIGS. 1 to 7B.

Below, the driving system control method of the hybrid vehicle according to an exemplary embodiment of the present disclosure will be described with reference to FIG. 1, FIG. 2, FIG. 3, FIG. 4, FIG. 5, FIG. 6, FIG. 7, and FIG. 8, focusing on the operations of the superordinate controller (or hybrid vehicle driving system control device) 300.

First, the superordinate controller 300 may receive the setting information from the user input interface 100, and receive the driving system state information from the driving system state information provider 200 (S800).

Here, the setting information may include information related to whether the driving system balance control function is activated (e.g., activated or deactivated), the driving system balance control level (e.g., 0, high, middle, and low), etc., and the driving system state information may include state information (e.g., engine deterioration degree) about the internal combustion driving system (e.g., engine), state information (e.g., motor deterioration degree and battery deterioration degree) about the electric driving system (e.g., motor and battery).

Accordingly, the superordinate controller 300 may be configured to determine the residual value (e.g., life expectancy) of the driving system based on the driving system state information, and determine the residual value (e.g., price) of the vehicle based on the residual values of the driving systems (S810).

In operation S810, the superordinate controller 300 may be configured to determine the residual value of the internal combustion driving system based on the engine the deterioration degree, and determine the residual value of the electric driving system based on the motor deterioration degree and the battery deterioration degree.

For example, the superordinate controller 300 may be configured to determine the residual values of the driving systems with reference to the internal combustion driving system residual value lookup table, in which the residual values of the internal combustion driving system are tabulated corresponding the engine deterioration degrees, and the electric driving system residual value lookup table, in which the residual values of the electric driving system are tabulated corresponding to the motor/battery deterioration degrees.

For example, the superordinate controller 300 may output the residual values of the driving systems and the residual value of the vehicle through the output interface 600.

Accordingly, the superordinate controller 300 is configured to determine whether the driving system balance control function is activated based on the setting information (S820), and terminates the driving system balance control operation when the controller concludes that the driving system balance control function is deactivated (No in S820).

In operation S820, the superordinate controller 300 may be configured to determine whether the driving system balance control function is activated based on information related to the activation ON/OFF of the driving system balance control function in the setting information.

When it is determined in operation S820 that the driving system balance control function is activated (Yes in S820), the superordinate controller 300 may be configured to determine whether the state of the vehicle satisfies the driving system balance control condition (S830).

In operation S830, the superordinate controller 300 may be configured to determine that the driving system balance control condition is satisfied when the vehicle driving mode is the hybrid mode, and the residual value of the internal combustion driving system is different from the residual value of the electric driving system.

When it is identified in operation S830 that the state of the vehicle does not satisfy the driving system balance control condition (No in S830), the superordinate controller 300 may terminate the driving system balance control operation.

When it is identified in operation 830 that the state of the vehicle satisfies the driving system balance control condition (Yes in S830), the superordinate controller 300 may be configured to determine whether the residual value V_{PT} of the internal combustion driving system is greater than the residual value V_{PE} of the electric driving system, or whether the residual value V_{PE} of the electric driving system is greater than the residual value V_{PT} of the internal combustion driving system (S840).

According to the determination results in operation S840, the superordinate controller 300 may perform the balance control between the residual value of the internal combustion driving system and the residual value of the electric driving system by changing the ratios of the engine torque and the motor torque to the total required torque (S850).

When it is identified in operation S840 that the residual value V_{PT} of the internal combustion driving system is greater than the residual value V_{PE} of the electric driving system (V_{PT}>V_{PE}), the superordinate controller 300 may increase the ratio of the engine torque and decrease the ratio of the motor torque (S850-1).

When it is identified in operation S840 that the residual value V_{PE} of the electric driving system is greater than the residual value V_{PT} of the internal combustion driving system (V_{PE}>V_{PT}), the superordinate controller 300 may increase the ratio of the motor torque and decrease the ratio of the engine torque (S850-2).

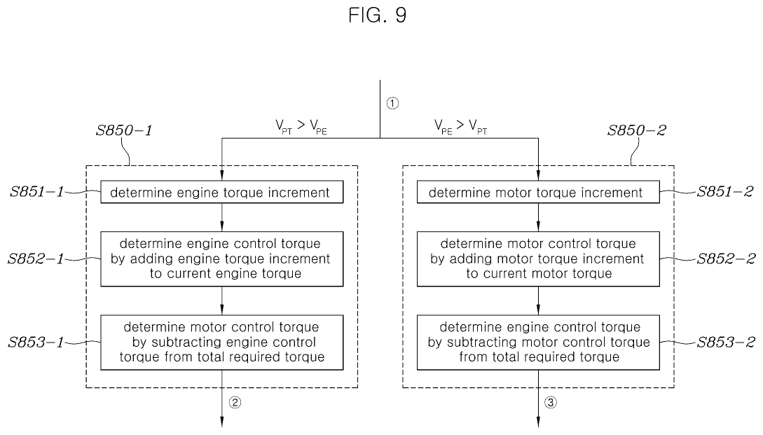

FIG. 9 is a flowchart for describing detailed operations of the driving system balance control S850 in FIG. 8.

Referring to FIG. 9, when the residual value V_{PT} of the internal combustion driving system is greater than the residual value V_{PE} of the electric driving system (V_{PT}>V_{PE}), the superordinate controller 300 may be configured to determine the engine torque increment to increase the ratio of the engine torque (S851-1).

In operation S851-1, the superordinate controller 300 may be configured to determine the engine torque increment with reference to the engine torque increment lookup table based on the current residual values of the internal combustion system and the electric driving system.

In operation S851-1, the superordinate controller 300 may be configured to determine the engine torque increment with reference to the engine torque increment lookup table for each control level, based on the current residual values and control levels of the internal combustion system and the electric driving system, to reflect the driving system balance control level.

Furthermore, the superordinate controller 300 may be configured to determine the engine control torque by adding the engine torque increment to the current engine torque (S852-1), and determine the motor control torque by subtracting the engine control torque from the total required torque (S853-1).

When the residual value V_{PE} of the electric driving system is greater than the residual value V_{PT} of the internal combustion driving system (V_{PE}>V_{PT}), the superordinate controller 300 may be configured to determine the motor torque increment to increase the ratio of the motor torque (S851-2).

In operation S851-2, the superordinate controller 300 may be configured to determine the motor torque increment with reference to the motor torque increment lookup table based on the current residual values of the internal combustion system and the electric driving system.

In operation S851-2, the superordinate controller 300 may be configured to determine the motor torque increment with reference to the motor torque increment lookup table for each control level based on the current residual values and control levels of the internal combustion system and the electric driving system, to reflect the driving system balance control level.

Furthermore, the superordinate controller 300 may be configured to determine the motor control torque by adding the motor torque increment to the current motor torque (S852-2), and determine the engine control torque by subtracting the motor control torque from the total required torque (S853-2).

According to an exemplary embodiment of the present disclosure, the residual value of the hybrid vehicle is raised by maintaining the states of the different driving systems in balance according to the residual values determined based on the states of the internal combustion/the electric driving systems in the hybrid vehicle,

Therefore, the residual values of the driving systems are raised through the driving system balance control for the hybrid vehicle, and thus, in terms of price and marketability, the hybrid vehicle is expected to gain an advantage over other vehicles in a used vehicle sales market.

As described above, the residual value of the hybrid vehicle according to an exemplary embodiment of the present disclosure may be preserved by the driving mode control and the clutch control in addition to the operating point control.

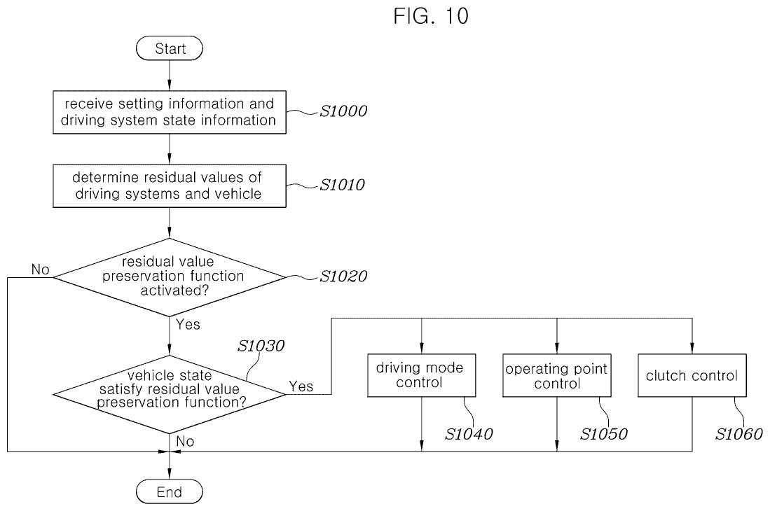

In other words, the adjustment for the torque ratio between the internal combustion driving system and the electric driving system described with reference to FIG. 9 and FIG. 10 are performed based on the operating point control which is one of the methods of preserving the residual value of the hybrid vehicle.

FIG. 10 is a flowchart for describing an overall process of residual value preservation control for a hybrid vehicle according to an exemplary embodiment of the present disclosure.

Referring to FIG. 10, the superordinate controller 300 may receive the setting information from the user input interface 100, and receive the driving system state information from the driving system state information provider 200 (S1000).

Here, the setting information may include information related to whether the driving system balance control function is activated (e.g., activated or deactivated), the driving system balance control level (e.g., 0, high, middle, and low), etc., and the driving system state information may include state information (e.g., engine deterioration degree) about the internal combustion driving system (e.g., engine), state information (e.g., motor deterioration degree and battery deterioration degree) about the electric driving system (e.g., motor and battery).

Accordingly, the superordinate controller 300 may be configured to determine the residual value (e.g., life expectancy) of the driving system based on the driving system state information, and determine the residual value (e.g., price) of the vehicle based on the residual values of the driving systems (S1010).

In operation S1010, the superordinate controller 300 may be configured to determine the residual value of the internal combustion driving system based on the engine the deterioration degree, and determine the residual value of the electric driving system based on the motor deterioration degree and the battery deterioration degree.

For example, the superordinate controller 300 may be configured to determine the residual values of the driving systems with reference to the internal combustion driving system residual value lookup table, in which the residual values of the internal combustion driving system are tabulated corresponding the engine deterioration degrees, and the electric driving system residual value lookup table, in which the residual values of the electric driving system are tabulated corresponding to the motor/battery deterioration degrees.

For example, the superordinate controller 300 may output the residual values of the driving systems and the residual value of the vehicle through the output interface 600.

Accordingly, the superordinate controller 300 may be configured to determine whether the residual value preservation function is activated based on the setting information (S1020), and terminate the residual value preservation control operation when it is determined that the residual value preservation function is deactivated (No in S1020).

The determination of the activation of the driving system balance control function, performed in operation S820 of FIG. 8, may be involved in the determination of the activation of the residual value preservation function, performed in operation S1020 of FIG. 10.

When it is determined in operation S1020 that the residual value preservation function is activated (Yes in S1020), the superordinate controller 300 may be configured to determine whether the state of the vehicle satisfies the residual value preservation control condition (S1030)

The determination of whether the state of the vehicle satisfies the driving system balance control condition, performed in operation S830 of FIG. 8, may be involved in the determination of whether the state of the vehicle satisfies the residual value preservation control condition, performed in operation S1030 of FIG. 10.

In operation S1030, the superordinate controller 300 may be configured to determine that the residual value preservation control condition is satisfied when the vehicle driving mode is the hybrid mode, and the residual value of the internal combustion driving system is different from the residual value of the electric driving system.

When it is identified in operation S1030 that the state of the vehicle does not satisfy the residual value preservation control condition (No in S1030), the superordinate controller 300 may terminate the operations of the residual value preservation control.

When it is identified in S1030 that the state of the vehicle satisfies the residual value preservation control condition (Yes in S1030), the superordinate controller 300 may perform at least one of the driving mode control (S1040), the operating point control (S1050) and the clutch control (S1060).

In operation S1040, the superordinate controller 300 may adjust the power output condition of at least one between the internal combustion driving system and the electric driving system.

The superordinate controller 300 may highly adjust the power output condition (ex, output frequency, output period, output level, etc.) of the driving system including a low residual value between the internal combustion driving system and the electric driving system to alleviate the decline in the residual value of the driving system including a relatively low residual value.

The superordinate controller 300 may lowly adjust the power output condition (ex, output frequency, output period, output level, etc.) of the driving system including a relatively high residual value (in other words, ease the power output of that driving system).

In operation S1050, the superordinate controller 300 may adjust the distribution ratios of the torque required for the internal combustion driving system and the electric driving system as described with reference to FIG. 8 and FIG. 9.

In operation S1060, the superordinate controller 300 may highly adjust the engagement state changing conditions of the clutch.

When the engagement state changing condition of the clutch is highly adjusted, it becomes difficult for the clutch to change from an engagement state to a disengagement state or from the disengagement state to the engagement state, reducing the state change of the clutch. The more frequently the clutch is changed in state, the more the residual value of the clutch may be lowered. Therefore, the decline in the residual value of the clutch is alleviated by highly adjusting the engagement state changing condition of the clutch as above.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for controlling driving systems including an internal combustion driving system and an electric driving system in a hybrid vehicle, the apparatus comprising:
a driving system controller configured to determine residual values of the internal combustion driving system and the electric driving system based on driving system state information, compare the residual value of the internal combustion driving system and the residual value of the electric driving system, and increase torque of a driving system including a high residual value and decrease torque of a driving system including a low residual value among the internal combustion driving system and the electric driving system in terms of satisfying total required torque.

2. The apparatus of claim 1, wherein the internal combustion driving system includes an engine, and the electric driving system includes a motor and a battery.

3. The apparatus of claim 1, wherein the driving system controller is further configured to determine the residual value of the internal combustion driving system based on a deterioration degree of an engine in the internal combustion driving system, and determine the residual value of the electric driving system based on a deterioration degree of a motor in the electric driving system and a deterioration degree of a battery in the electric driving system.

4. The apparatus of claim 1, wherein the driving system controller is further configured to perform driving system balance control in response that a driving system balance control function is activated, a vehicle driving mode is a hybrid mode, and the residual value of the internal combustion driving system is different from the residual value of the electric driving system.

5. The apparatus of claim 1, wherein the driving system controller is further configured to determine the residual value of the hybrid vehicle based on the residual value of the internal combustion driving system and the residual value of the electric driving system.

6. The apparatus of claim 1, wherein the driving system controller is further configured to determine a torque increment of a torque increasing driving system, determine control torque of the torque increasing driving system by adding the torque increment to current torque of the torque increasing driving system, and determine control torque of a torque decreasing driving system by subtracting the control torque of the torque increasing driving system from the total required torque.

7. The apparatus of claim 1, wherein the driving system controller is further configured to determine a torque increment of an engine in the internal combustion driving in response that the residual value of the internal combustion driving system is greater than the residual value of the electric driving system, determine engine control torque by adding the torque increment to current torque of the engine, and determine motor control torque by subtracting the engine control torque from the total required torque.

8. The apparatus of claim 1, wherein the driving system controller is further configured to determine a torque increment of a motor in the electric driving system in response that the residual value of the electric driving system is greater than the residual value of the internal combustion driving system, determine motor control torque by adding the torque increment to current torque of the motor, and determine engine control torque by subtracting the motor control torque from the total required torque.

9. The apparatus of claim 6, wherein the driving system controller is further configured to determine the torque increment based on an increment lookup table where torque increments are tabulated corresponding to the residual values of the internal combustion system and the electric driving system.

10. The apparatus of claim 6, wherein the driving system controller is further configured to determine the torque increment based on an increment lookup table for each control level, in which torque increments are tabulated corresponding to the residual values and control levels of the internal combustion system and the electric driving system, to reflect a driving system balance control level.

11. A method of controlling driving systems including an internal combustion driving system and an electric driving system in a hybrid vehicle, the method comprising:
determining, by a processor, residual values of the internal combustion driving system and the electric driving system based on driving system state information;
comparing, by the processor, the residual value of the internal combustion driving system and the residual value of the electric driving system; and
performing, by the processor, driving system balance control by increasing torque of a driving system including a high residual value and decreasing torque of a driving system including a low residual value among the internal combustion driving system and the electric driving system, based on comparison results, in terms of satisfying total required torque.

12. The method of claim 11, wherein the determining includes determining the residual value of the internal combustion driving system based on a deterioration degree of an engine in the internal combustion driving system, and determining the residual value of the electric driving system based on a deterioration degree of a motor in the electric driving system and a deterioration degree of a battery in the electric driving system.

13. The method of claim 11, wherein the determining includes determining a residual value of the hybrid vehicle based on the residual value of the internal combustion driving system and the residual value of the electric driving system.

14. The method of claim 11, wherein the comparing is performed in response that a driving system balance control function is activated, a vehicle driving mode is a hybrid mode, and the residual value of the internal combustion driving system is different from the residual value of the electric driving system.

15. The method of claim 11, wherein the performing the driving system balance control includes:
determining a torque increment of a torque increasing driving system;
determining control torque of the torque increasing driving system by adding the torque increment to current torque of the torque increasing driving system; and
determining control torque of a torque decreasing driving system by subtracting the control torque of the torque increasing driving system from the total required torque.

16. The method of claim 11, wherein the performing the driving system balance control includes:
determining a torque increment of an engine in the internal combustion driving system in response that the residual value of the internal combustion driving system is greater than the residual value of the electric driving system;
determining engine control torque by adding the torque increment to current torque of the engine; and
determining motor control torque by subtracting the engine control torque from the total required torque.

17. The method of claim 11, wherein the performing the driving system balance control includes:
determining a torque increment of a motor in the electric driving system in response that the residual value of the electric driving system is greater than the residual value of the internal combustion driving system;
determining motor control torque by adding the torque increment to current torque of the motor; and
determining engine control torque by subtracting the motor control torque from the total required torque.

18. The method of claim 15, wherein the performing the driving system balance control includes:
determining the torque increment based on an increment lookup table where torque increments are tabulated corresponding to the residual values of the internal combustion system and the electric driving system.

19. The method of claim 15, wherein the performing the driving system balance control includes:
determining the torque increment based on to an increment lookup table for each control level, in which torque increments are tabulated corresponding to the residual values and control levels of the internal combustion system and the electric driving system, to reflect a driving system balance control level.

20. A system for controlling the driving systems in the hybrid vehicle, the system comprising:
a user input interface configured to receive setting information and to transmit the setting information about whether a driving system balance control function is activated, to the driving system controller;
a driving system state information provider that provides the driving system state information related to the driving systems of the hybrid vehicle to the driving system controller; and
the driving system controller of claim 1 in the hybrid vehicle; and
a subordinate controller operatively connected to the driving system controller and configured to control a powertrain apparatus based on driving system balance control of the driving system controller in the hybrid vehicle.
